(19) United States
(12) Patent Application Publication
(10) Pub. No.: US 2011/0262646 A1
(43) Pub. Date: Oct. 27, 2011

(54) Surfactant-Assisted Inorganic Nanoparticle Deposition on a Cellulose Nanocrystals

(75) Inventors: Lia Antoaneta Stanciu, West Lafayette, IN (US); Sonal Padalkar, Evanston, IL (US); Robert John Moon, West Lafayette, IN (US)

(73) Assignee: PURDUE RESEARCH FOUNDATION, West Lafayette, IN (US)

(21) Appl. No.: 13/023,627

(22) Filed: Feb. 9, 2011

Related U.S. Application Data
(60) Provisional application No. 61/327,191, filed on Apr. 23, 2010.

(51) Int. Cl. B05D 5/00; B05D 7/00; B05D 3/10; B82Y 40/00; B82Y 30/00

(52) U.S. Cl. 427/308; 427/343; 977/890

(57) ABSTRACT

Natural biopolymers in the form of cellulose nanocrystals (CNC) are shown to have the required characteristics to serve as chemically reactive biotemplates for metallic and semiconductor nanomaterial synthesis. Silver (Ag), gold (Au), copper (Cu) and platinum (Pt), cadmium sulfide (CdS), zinc sulfide (ZnS) and lead sulfide (PbS) nanoparticles, nanoparticle chains and nanowires may be synthesized on CNCs by exposing metallic precursor salts to a cationic surfactant, cetyltrimethylammonium bromide (CTAB), and a reducing agent. The nanoparticle density and particle size may be controlled by varying the concentration of CTAB, pH of the salt solution, as well as the reduction time or reaction time between the reducing agent and the metal precursor.

### US GOVERNMENT RIGHTS

This disclosed methods were invented with Government support under Contract No.: SPS-00007781, awarded by the U.S. Forest Service-Forest Products Laboratory. The Government may have certain rights to this application.

### TECHNICAL FIELD

This disclosure relates generally to systems and methods for synthesizing metallic and semiconductor nanomaterials on biopolymer templates. More specifically, this disclosure relates to the synthesis of metallic and semiconductor nanomaterials on cellulose nanocrystals (CNCs) and, still more specifically, the synthesis of silver, gold, copper, platinum, cadmium sulfide, zinc sulfide and lead sulfide nanoparticles, nanochains, nanowires and other 1D nanostructures on CNCs.

### BACKGROUND

Biomineralization and biotemplating are areas that have emerged as attractive fields of research in recent years due to the nanometer size scale of biomolecules and assemblies thereof. The relative size of biomolecules allows for the processing of template structures within a similar size regime. Biomolecules also have the advantage of being chemically modifiable, which in turn brings the potential of chemically manipulating and positioning them in complex devices.

Among the various types of biomolecules, proteins, viruses and DNA have been the most widely investigated biological templates for nanomaterial synthesis. Others possible biological templates include microtubules, β-amyloid, Sup35NM (a yeast protein), the tobacco mosaic virus and α-synuclein. These biomolecules possess the unique combination of having nanoscale dimensions and favorable surface charge that facilitates the synthesis of one dimensional 1D) nanostructures, such as nanowires, nanorods, nanotubes etc. However, the above mentioned biomolecules are often difficult to isolate in appreciable quantities and therefore expensive, which limits their attractiveness for their use in the fabrication of 1D nanostructures.

Alternatively, cellulose nanocrystals (CNCs) display nanoscale size dimensions (5-20 nm diameter, 25-3000 nm length) and a rod-like geometry, while having a completely different chemical structure than proteins or DNA. Cellulose is abundantly available, relatively inexpensive, and with free hydroxyl groups exposed on the outer surface, CNCs can be easily chemically functionalized. There are many sources from which CNCs can be obtained including tunicates, forest products, stalks, grasses, or reeds. Tunicates are also the only animals able to create cellulose. Tunicates, also known as urochordates, are members of the subphylum Tunicata or Urochordata, a group of underwater saclike filter feeders with incurrent and excurrent siphons that are classified within the phylum Chordata. Tunicate CNCs have been isolated using known techniques. Despite the abundance and availability of CNCs, the exploitation of CNCs as biotemplates for production of metallic and semiconductor nanomaterials has yet to be accomplished, nor has reliable and cost effective protocols been developed.

Materials capable of being formed into nanoparticles and nanochains such as cadmium sulfide (CdS), lead sulfide (PbS), and zinc sulfide (ZnS) as well as silver (Ag), gold (Au), copper (Cu) and platinum (Pt) have found applications in the design of semiconductors, solar cells and other optoelectronic and electronic devices. CdS is an II-VI semiconducting material with a direct band gap of 2.42 eV. This band gap falls within the visible region of the spectrum and can be used in the form of nanowires, nanotubes and quantum dots for investigating applications like nonlinear optical devices, photovoltaic cells, and thin film transistors. ZnS also belongs to the same class of semiconducting materials having a band gap of 3.7 eV. ZnS is photoluminescent and has field emission properties, which have be explored for applications in light converting electrodes, ultraviolet light emitting diodes and phosphors in cathode ray tubes.

There is a need for commercially viable systems and methods that employ CNCs as biological templates for the synthesis of metal sulfide and metallic nanostructures.

### SUMMARY OF THE DISCLOSURE

In one example, CNCs are used as a biological template in a reductive deposition procedure for metal nanoparticle decoration of the CNCs that includes the use of the cationic surfactant. In a refinement, the cationic surfactant is cetyltrimethylammonium bromide (CTAB).

In another example, CNCs are used as biological templates for the synthesis of Ag, Au, Cu, Pt, CdS, PbS and ZnS nanoparticles and nanostructures using a protocol that makes use of the cationic surfactant.

In a refinement, the CNCs are extracted tunicate cellulose nanocrystals. In another refinement, the tunicate CNCs are sulfate functionalized.

In a refinement, a disclosed method for synthesizing metal-containing nanostructures on cellulose nanocrystals (CNCs) comprises: exposing CNCs and a cationic surfactant to a metal precursor; and exposing the CNCs, cationic surfactant and metal precursor to a reducing agent.

In a refinement, the exposing of the CNCs to the cationic surfactant is carried out in the presence of a solid support and the cationic surfactant is CTAB, provided in an aqueous solution. In a refinement, the solid support is a transition electron microscope (TEM) carbon coated copper grid substrate.

In a refinement, the exposing of the CNCs to the cationic surfactant is carried out in an acidic, aqueous solution.

In a refinement, a pH of the acidic, aqueous solution ranges from about 4 to about 2.

In a refinement, the cationic surfactant solution has a concentration ranging from about 0.1 to about 1.0 mM. In a refinement, the cationic surfactant solution has a concentration of about 0.5 mM.

In a refinement, the metal precursor is provided in the form of an aqueous solution. In a refinement, the metal precursor solution has a concentration ranging from about 0.5 to about 0.8 mM.

In a refinement, the metal precursor is selected from the group consisting of AgNO₃, CuCl₂, HAuCl₄, K₂PtCl₄, CdCl₂, Pb(NO₃)₂ and ZnCl₂.

In a refinement, the reducing agent is selected from the group consisting of NaBH₄ and H₂S. In a refinement, the reducing agent is NaBH₄ and the NaBH₄ provided in a 0.03 wt % solution and the exposing of the CNCs, cationic surfactant and metal precursor to the 0.03 wt % NaBH₄ solution is carried out over a time period ranging from about 2 to about 30 minutes. In another refinement, the reducing agent is H₂S gas and the exposing of the CNCs, cationic surfactant and metal precursor to the H₂S gas is carried out over a time period ranging from about 2 to about 10 minutes.

In a refinement, before the exposing of the CNCs to the cationic surfactant, the CNCs are hydrolyzed with sulfuric acid to provide sulfate-functionalized CNCs. In another refinement, the CNCs are tunicate CNCs.

Another disclosed method for synthesizing metal nanostructures on cellulose nanocrystals (CNCs) comprises: providing CNCs in an aqueous, acidic solution; combining the CNCs with a cetyltrimethylammonium bromide (CTAB) solution; combining the CNCs and CTAB with a metal precursor solution, the metal precursor solution being selected from the group consisting of an AgNO₃ solution, a CuCl₂ solution, a HAuCl₄ solution and a K₂PtCl₄ solution; and exposing the CNCs, CTAB and metal precursor to NaBH₄.

Another disclosed method for synthesizing metal nanostructures on cellulose nanocrystals (CNCs) comprises: providing CNCs in an aqueous, acidic solution; exposing the CNCs to a cetyltrimethylammonium bromide (CTAB) solution; combining the CNCs and CTAB with a metal precursor solution, the metal precursor solution being selected from the group consisting of a CdCl₂ solution, a ZnCl₂ solution and a Pb(NO₃)₂ solution; and exposing the CNCs, CTAB and metal precursor to H₂S gas.

### BRIEF DESCRIPTION OF THE DRAWINGS

FIGS. 1-2 are TEM images of CNC/CdS made without the use of CTAB (FIG. 1) and with the use of CTAB (0.5 mM; FIG. 2) in a synthesis procedure using a precursor concentration of 2.5 mM (CdCl₂) and the H₂S exposure time of about 2 min.

FIG. 3 illustrates a proposed synthesis mechanism for the formation of Ag nanoparticles on the surface of CNCs, wherein the CTAB cationic surfactant stabilizes the metallic nanoparticles inside its micelles, which are attached to the surface of CNCs via non-covalent bonding.

FIGS. 4-6 are TEM images of Ag nanoparticle synthesis on tunicate CNCs that are: synthesized on a solid support, in the absence of CTAB (FIG. 4); synthesized on a solid support, in the presence of CTAB (FIG. 5); and synthesized in the absence of a solid support but in the presence of CTAB with the CNCs suspended in DI water (FIG. 6), thereby illustrating that, regardless of synthesis being performed on a solid support (FIG. 5) or in solution (FIG. 6), when CTAB is used, there is improved Ag precipitation (compare FIGS. 5-6 with FIG. 4).

FIG. 7 is an HRTEM image of an Ag nanoparticle on a CNC, wherein the inset shows the interplanar spacing to be about 0.23 nm, which can be attributed to two 111 planes of Ag.

FIG. 8 is a TEM image of Ag nanoparticles on a CNC surface.

FIG. 9 shows the EELS spectrum for the Ag nanoparticles of FIG. 8 showing an energy loss edge at about 367 eV.

FIG. 10 shows four TEM images with varying concentrations of CTAB, (a) 0.1 mM, (b) 0.2 mM, (c) 0.5 mM and (d) 1.0 mM, illustrating that an optimum Ag nanoparticle synthesis on tunicate CNC occurs at about 0.5 mM.

FIG. 11 shows the UV-Vis absorption spectrum of Ag nanoparticles for 0.2 mM, 10 mM, 100 mM, and 1 M concentrations of AgNO₃ salt solution, wherein for 0.2-100 mM AgNO₃ concentrations, an absorption peak at about 405 nm was observed, while for 1 M concentration (see inset), an absorption peak was shifted to about 425 nm.

FIGS. 12-13 are TEM images of Ag nanoparticle samples produced with varying pHs of the AgNO₃ salt solution including a pH of 4.5 (FIG. 12) and a pH of 8.5 (FIG. 13), thereby showing larger Ag particle sizes on the CNCs as well as increased Ag particle formation on the substrate at the lower pH of FIG. 13.

FIG. 14 are four TEM images of Ag nanoparticle made with varying NaBH₄ reducing times of (a) 2 min, (b) 5 min, (c) 15 min, and (d) 30 min, showing a general trend toward larger particle size with increasing reduction times.

FIG. 15 is a TEM image of Cu nanoparticles on a cellulose template.

FIG. 16 shows an absorption spectrum obtained from the Cu sample of FIG. 15, showing an absorption peak at about 600 nm.

FIG. 17 is a TEM image of Au nanoparticles on a cellulose template.

FIG. 18 shows an absorption spectrum obtained from the Au sample of FIG. 17, showing an absorption peak at about 535 nm.

FIG. 19 is a TEM image of Pt nanoparticles on a cellulose template.

FIG. 20 shows an absorption spectrum obtained from the Pt sample FIG. 19, showing an absorption peak in the range of from about 210 to about 300 nm.

FIGS. 21-23 are HRTEM images of CdS (FIG. 21), PbS (FIG. 22) and ZnS (FIG. 23) nanoparticle chains showing the morphology of the individual particles.

FIGS. 24-25 show EELS spectra obtained from the CdS sample of FIG. 21 showing the cadmium M_{4,5} edge at 404 eV (FIG. 24) and the sulfur L_{2,3} edge at 165 eV (FIG. 25), along with the Carbon K edge at about 300 eV.

FIGS. 26-27 show EELS spectra obtained from the PbS sample of FIG. 22 showing the lead O_{2,3} edge at 86 eV (FIG. 26) and the sulfur L_{2,3} edge at 165 eV (FIG. 27), along with the Carbon K edge at about 300 eV.

FIGS. 28-29 are TEM images of CdS nanoparticles (FIG. 28) and ZnS nanoparticles (FIG. 29) coated on CNCs and prepared from the disclosed solution method and subsequently deposited on a TEM grid for imaging.

FIGS. 30-31 are TEM images of CdS nanoparticles on CNC surface produced by varying the pH of the CdCl₂ solution from pH of 4.0 (FIG. 30) to a pH of 7.0 (FIG. 31).

FIGS. 32-33 are TEM images of ZnS nanoparticle samples produced by varying the pH of the ZnCl₂ solution from a pH of 4.0 (FIG. 32) to a pH of 7.0 (FIG. 33).

FIGS. 34-36 are TEM images of CdS nanoparticle samples made by varying the H₂S exposure time from 2 min (FIG. 34) to 5 min (FIG. 35) to 10 min (FIG. 36), the inset of FIG. 36 showing the agglomerate-like morphology of the CdS nanoparticle.

FIGS. 37-39 are TEM images of PbS nanoparticle samples made by varying the H₂S exposure time from 2 min (FIG. 37) to 5 min (FIG. 38) to 10 min (FIG. 39), the inset of FIG. 39 showing the cube-like morphology of the PbS nanoparticle.

FIGS. 40-42 are TEM images of ZnS nanoparticle sample made by varying the H₂S exposure time from 2 min (FIG. 40) to 5 min (FIG. 41) to 10 min (FIG. 42), the inset of FIG. 42 showing the agglomerate-like morphology of the ZnS nanoparticle.

FIG. 43 illustrates, schematically, a proposed mechanism of cellulose template synthesis of semiconductor nanoparticle chains, wherein the CTAB cationic surfactant stabilizes the semiconducting nanoparticles inside its micelles, which are attached to the surface of CNCs via non-covalent bonding.

FIGS. 44-45 are TEM images of CdS particles synthesized from CdCl₂ and H₂S with CTAB (FIG. 44) and from CdCl₂ and H₂S without CTAB (FIG. 45).

### DETAILED DESCRIPTION

### Tunicate Cellulose Nanocrystal Extraction

CNCs were synthesized via acid hydrolysis (sulfuric acid) from tunicates according to a method reported in literature. Briefly, tunicates (Styela Clava) were heated at 80° C. for 24 h in an aqueous solution of potassium hydroxide (3 L, 5% w/w per 500 g of tunicate walls) and agitated mechanically. Two more cycles of heating at 80° C. for 24 h, in a same concentration as previous solution of KOH were performed. The raw cellulose was washed with water at neutral pH, followed by treatment cycles with 5 ml acetic acid and 10 ml of hypochlorite solution. Next, the suspension was heated at 60° C. The acetic acid and hypochlorite treatments were repeated at 1 h intervals until a white color of the cellulose was registered. In the final step, the cellulose was washed with water and transformed into a pulp with a Warring blender. Sulfuric acid hydrolysis of cellulose pulp was performed to obtain sulfate-functionalized tunicate CNCs, which provides a good dispersion of the CNCs.

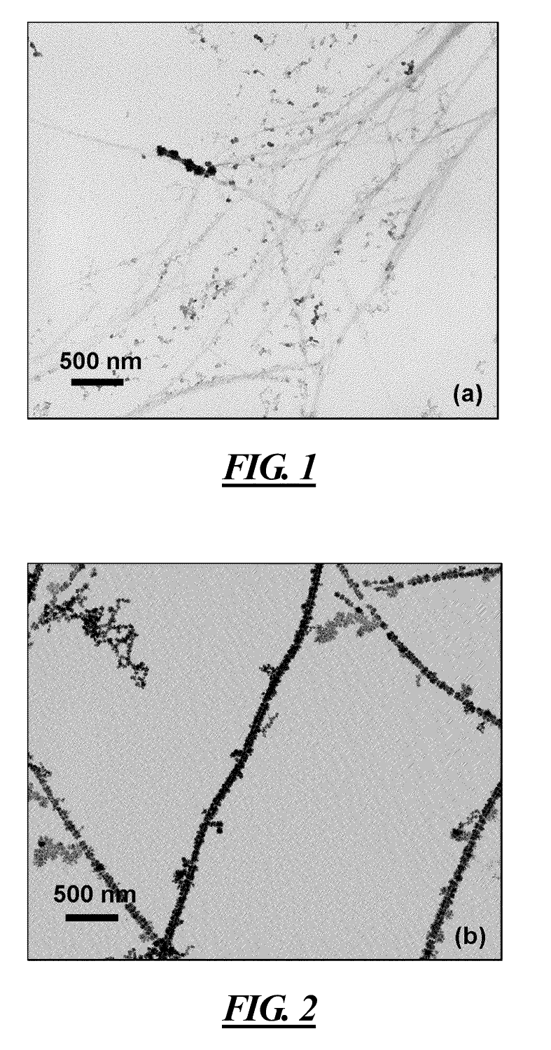

The CNCs had a diameter ranging from about 10 to about 20 nm and a length between about 100 nm to about several micrometers as reported in literature and confirmed by the Transmission Electron Microscope (TEM) image in FIG. 1. The CNCs were dispersible in water, which has been attributed to a small concentration of negatively charged sulfate groups on their surface left over from the acid hydrolysis extraction process. The concentration of sulfate groups on the CNC surfaces from sulfuric acid hydrolysis extraction processes has been reported as being very low and results in surface charge density of about 84 mmol kg-1. For subsequent experiments, the starting CNC suspension was diluted (100 μL, of 2 wt % CNC solution was added to 10 ml of distilled water) and had a pH of about 6.

### Role of CTAB on Metal and Metal Sulfide Synthesis on CNCs

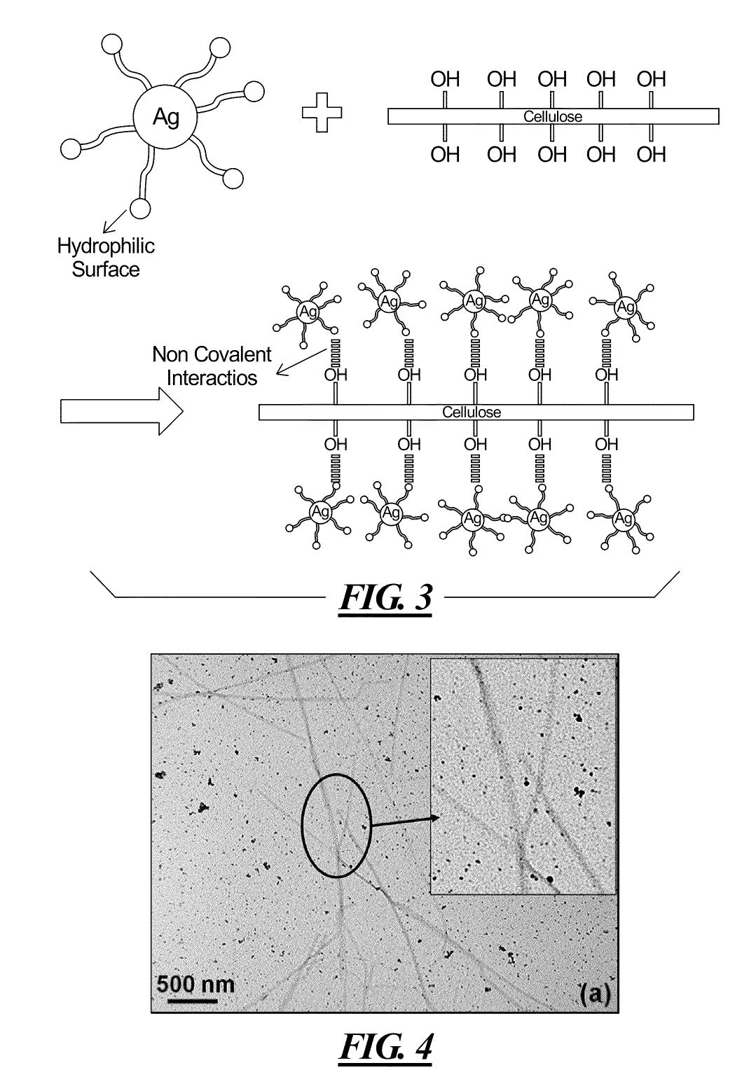

Increasingly, surfactants have been used by chemists and materials scientists as template systems for the stabilization of various types of nanocrystals and nanostructures. CTAB is a cationic surfactant that assembles into micelles in aqueous solution as shown schematically in FIG. 3.

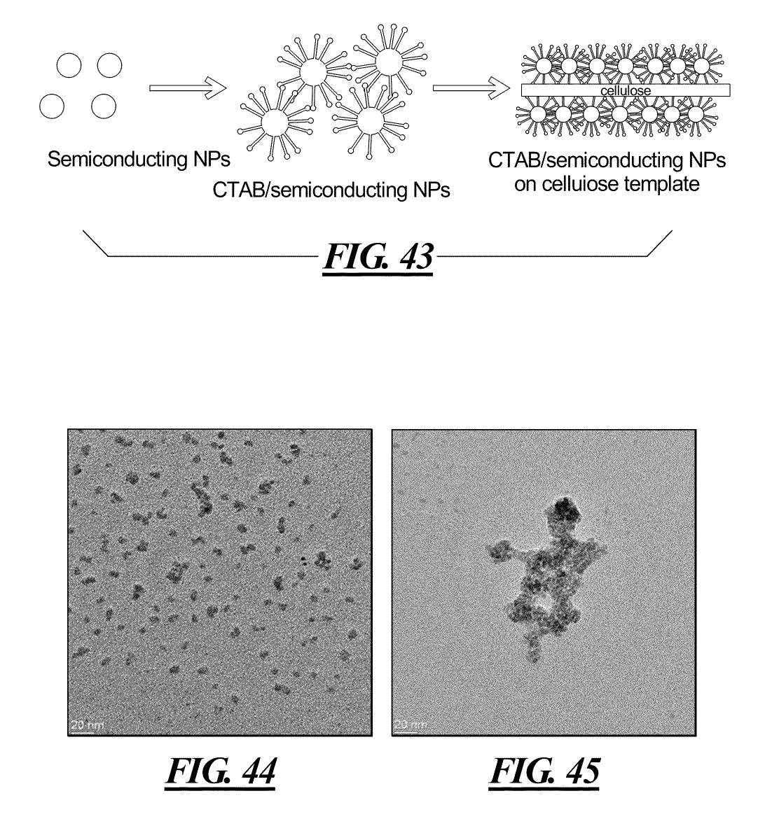

CTAB was used in the successful synthesis of CdS, PbS and ZnS nanowires and we proposed a potential mechanism for this process (FIG. 43). From the TEM images in FIGS. 1-2, it can be observed that there is very little coverage of the CNCs occurs in the absence of CTAB (FIG. 1) as most particles are deposited in between individual cellulose nanocrystals. The small amount of CdS formed on the template shown in FIG. 1 could be due to the negative charges of the CNCs that are originating from their synthesis procedure. In contrast, in the presence of CTAB as shown in FIG. 2, there is a significant increase in the CdS coverage on the CNC surface.

FIG. 3 shows a proposed mechanism for the biotemplated synthesis of metallic nanoparticles on the CNC surfaces that are reported in this work. Based on previous work that showed that CTAB indeed acts as a stabilizer of inorganic nanoparticles, it is speculated that Ag nanoparticles are first formed via conventional reduction of AgNO₃, and CTAB acts as a stabilizer for the Ag nanoparticles. These stabilized nanoparticles, which are covered in polar cationic quaternary ammonium groups, can then non-covalently interact with the polar surface of the CNC nanocrystals which is rich in free hydroxyl groups. A similar mechanism is proposed for the metal sulfide synthesis below in connection with FIG. 43.

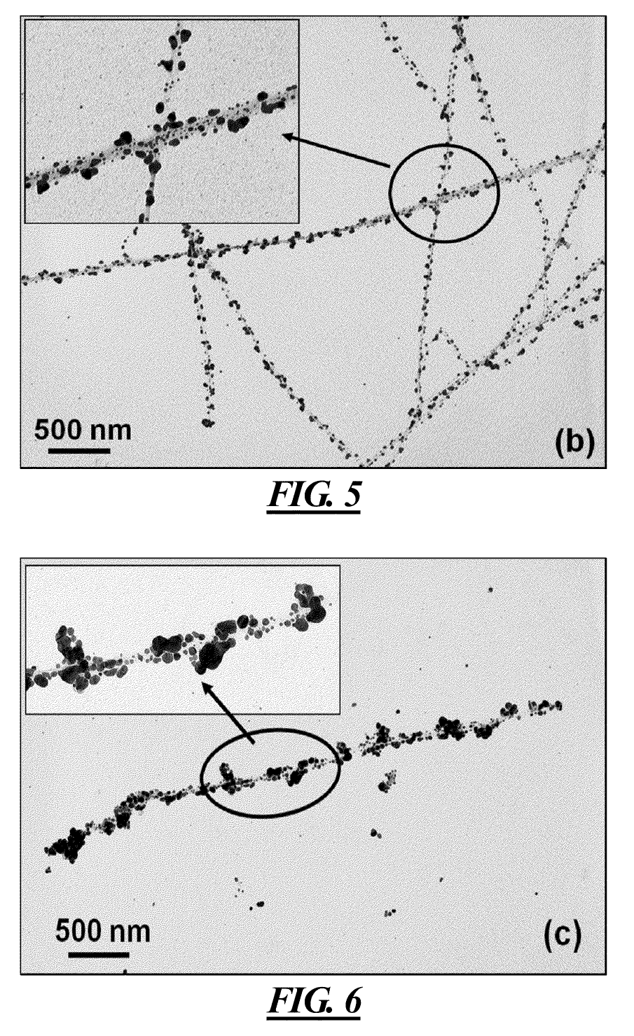

Although the proposed mechanisms are not definitive, the theoretical reasoning described above is also supported by the experimental observations that show that for the metal nanoparticle synthesis procedure excluding CTAB, there was minimal metal nanoparticle formation on the CNCs (FIG. 4). This is attributed to the fact that cellulose displays mostly neutral hydroxyl groups (FIG. 43) which do not interact strongly with the nanoparticles. The sulfate-functionalized tunicate CNCs should have a negative surface charge resulting from the partial sulfonation of the CNCs as a consequence of the sulfuric acid hydrolysis step in the isolation procedure, but it is considered here that charge density on the CNCs is insufficient to result in significant formation of metallic nanoparticles on the CNC surface. FIGS. 4-6 confirm this point of view by showing that in the absence of CTAB, as a nanoparticle stabilizer and connector to the tunicate nanocrystals, only nonspecific precipitation of Ag nanoparticles was observed (FIG. 4). After the inclusion of CTAB into the reaction process with a solid support, Ag nanoparticles are deposited preferentially on the CNC surfaces (FIG. 5). The Ag particle size was poly-dispersed, and varied between 1 and 20 nm depending on the processing conditions.

The deposition of Ag on CNC surfaces using CTAB was also confirmed for CNCs suspended in DI water (FIG. 6). For this case, all the steps of the Ag nanoparticle synthesis on CNCs surface were performed in solution. FIG. 6 shows that the CNC surface is decorated with Ag particles and therefore the chemical reactions involved in the decoration of CNCs with Ag nanoparticles, in the presence of CTAB do not need a solid support to occur. Additionally, the depositions of Au, Cu, and Pt on CNC surfaces for processing configuration-b were also confirmed with subsequent TEM imaging.

### Metal Nanoparticle Synthesis on Cellulose Template:

A multi-step process was used to synthesize metallic nanoparticles (Ag, Au, Cu, and Pt) on the surfaces of tunicate CNCs. The same synthesis procedure was used successfully for metal nanoparticle decoration of CNCs in two different configurations: a) CNCs first deposited on a carbon coated copper TEM grid, and the resulting samples were used for TEM analysis, and b) CNCs first dispersed in a DI water brought to an acidic pH (pH=2), and resulting samples were used for UV-Vis analysis. The steps of the procedure were: i) 3 μl of a CNC suspension (about 2 wt % in DI water with pH about 2) was placed on a TEM grid (for configuration-a described above). ii) 3 μl of CTAB (0.1-1.0 mM) was added to the CNC suspension and allowed to react for 5 min. iii) 3 μl of the metallic precursor solution (pH 4.5-8.5) was added into the CNC suspension and allowed to react for 5 min. iv) 3 μl of the reducing agent sodium borohydride (NaBH₄) (0.03 wt %) was added to the CNC suspension and held for 5 min. v) The substrate was washed with distilled water and dried in air. The synthesis of Ag, Au, Cu, and Pt nanoparticles followed the same procedure with the corresponding metal precursors used, 0.2 mM to 1 M silver nitrate (AgNO₃), 0.8 mM copper chloride (CuCl₂), 0.8 mM hydrogen tetrachloroaurate (HAuCl₄) and 0.5 mM potassium tetrachloroplatinate (K₂PtCl₄), respectively.

To obtain an optimum coverage and size distribution of metallic nanoparticles on the CNC surfaces, a study aimed at controlling the fabrication parameters was performed. The first step in this optimization process was to monitor the influence of the concentration of CTAB, followed by AgNO₃ concentration, pH and reducing time.

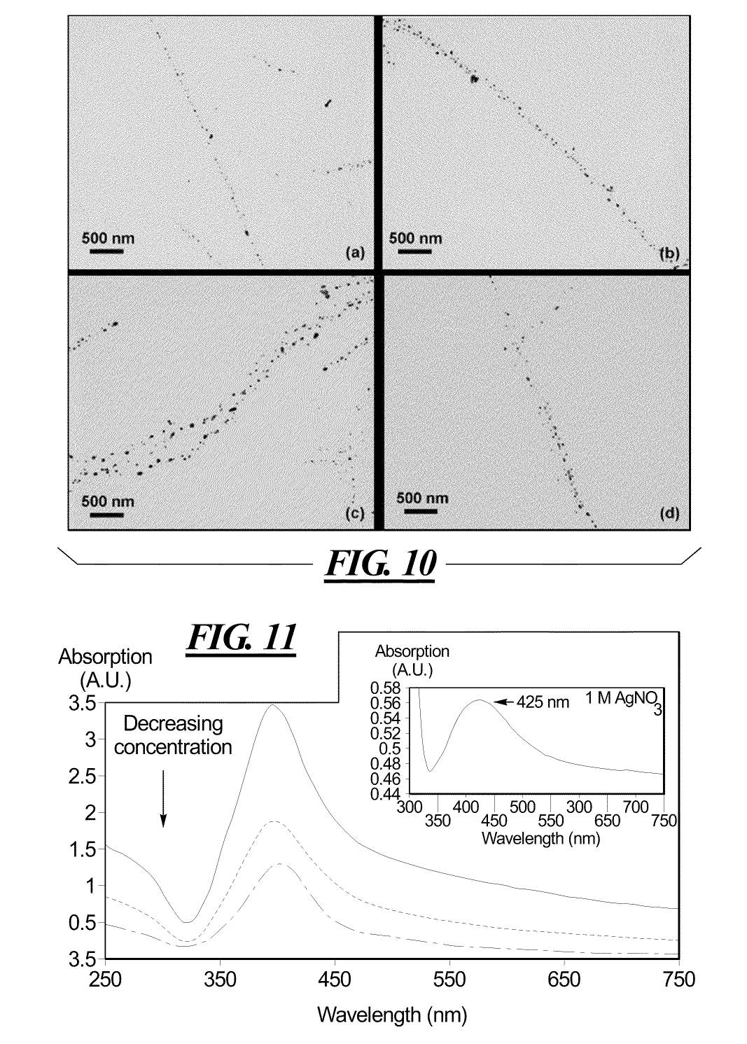

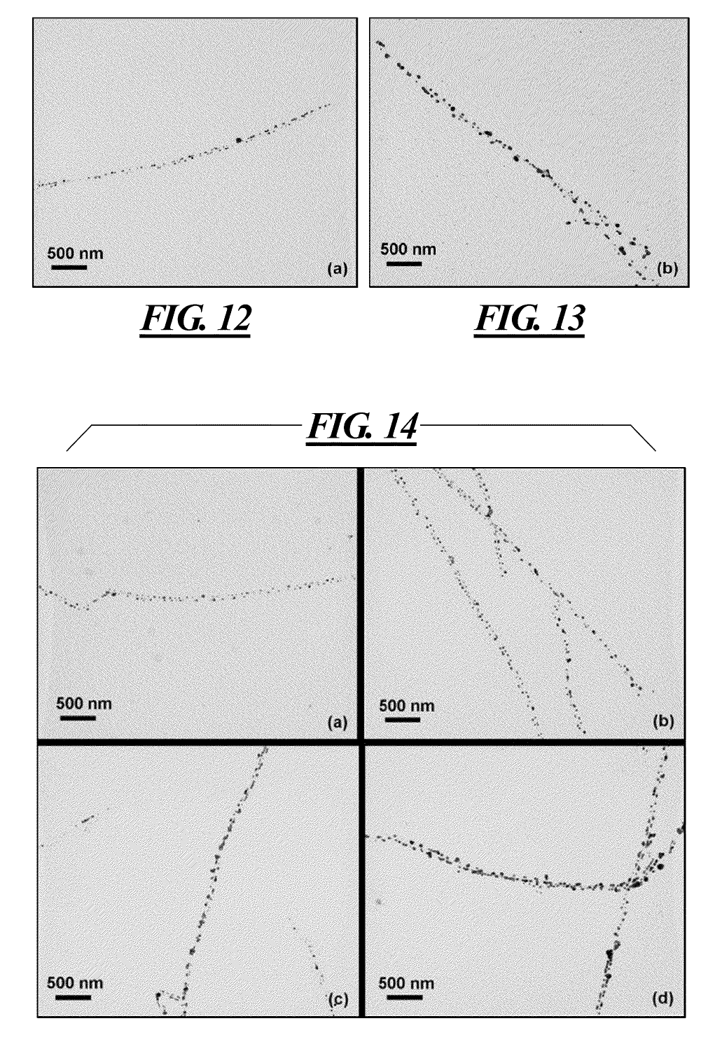

The concentration of CTAB was varied from 0.1 mM to 1.0 mM, while keeping the concentration of AgNO₃ to 0.2 mM at a pH of 6.5 and a reduction time of 2 minutes. The nanoparticle coverage increased gradually from 0.1 mM to 0.5 mM CTAB and then decreased for 1.0 mM of CTAB (FIG. 10). This is an expected effect, which is due to an increase in the number of available micelles for nanoparticle stabilization as the CTAB concentration increases from 0.1 mM to 0.5 mM. At a CTAB concentration of 1.0 mM, evidence in literature suggests that the CTAB micelles self-associate into nanorod like structures and therefore the real concentration of free CTAB micelles available for capping Ag nanoparticles and assembling them on the CNCs becomes reduced. Noting this, the 0.5 mM was considered to be the optimum concentration for the nanoparticle synthesis on the cellulose template. All further experiments were performed by keeping the CTAB concentration to 0.5 mM.

The concentration of AgNO₃ was varied from 0.2 mM to 1 M while the AgNO3 concentration was of 0.2 mM, the pH at 6.5 and the NaBH4 reduction time of 5 minutes. The effects on Ag nanoparticle formation as a function AgNO₃ concentration were measured by UV-Vis (FIG. 11). The absorption peak centered at about 405 nm, corresponds to Ag nanoparticles. The relatively narrow and symmetrical peaks in the UV-Vis spectra indicate a narrow Ag particle size distribution. By increasing the AgNO₃ concentration from 0.2 mM to 1 M, several observations could be made. As shown in FIG. 11, the spectra for 0.2 mM, 10 mM and 100 mM showed an unchanged absorption peak at about 405 nm. With increase in concentration above 100 mM, the peaks became broader, indicating a larger particle size distribution. Additionally, for 1 M AgNO₃, the UV-Vis spectrum appeared to red shift to about 425 nm (FIG. 11 inset), which is also considered a result from increased Ag particle size. The nucleation of new Ag nanoparticles occurs simultaneously with the growth of other particles. Once the first Ag nuclei are formed, the colliding nuclei start growing, while a higher concentration of AgNO₃ leads to the formation of new nuclei. This mechanism is also supported by evidence of an increase in polydispersity of Ag nanoparticles.

The pH of the AgNO₃ salt solution ([AgNO₃]=0.2 mM) was varied between 4.5 and 8.5. The NaBH₄ reducing time was kept constant at 5 minutes. With increased pH, the Ag particle size increased (FIG. 13). However, the higher pH values also resulted in a large amount of unspecific silver deposition on the substrate. These results are in agreement with other reports in literature, which indicate that at a basic pH, an aggregation of Ag nanoparticles obtained by surfactant stabilization and NaBH₄ reduction occurs. This effect can be attributed to hydrophobic interactions between uncharged CTAB molecules at slightly basic pH of about 8.5, rendering them insoluble, i.e. unable to stabilize and prevent Ag nanoparticles' aggregation.

The NaBH₄ reducing time was varied in FIG. 14 from 2 minutes in part (a) to 5 minutes in part (b) to 15 minutes in part (c) and then to 30 minutes in part (d). The pH of the AgNO₃ salt solution was set at 6.5 and the concentration was of 0.2 mM. The effect on Ag particle formation and size was analyzed by TEM (FIG. 14). With increased reaction times, the average Ag particle size increased from about 17 nm (part (a)) to about 36 nm (part (d)).

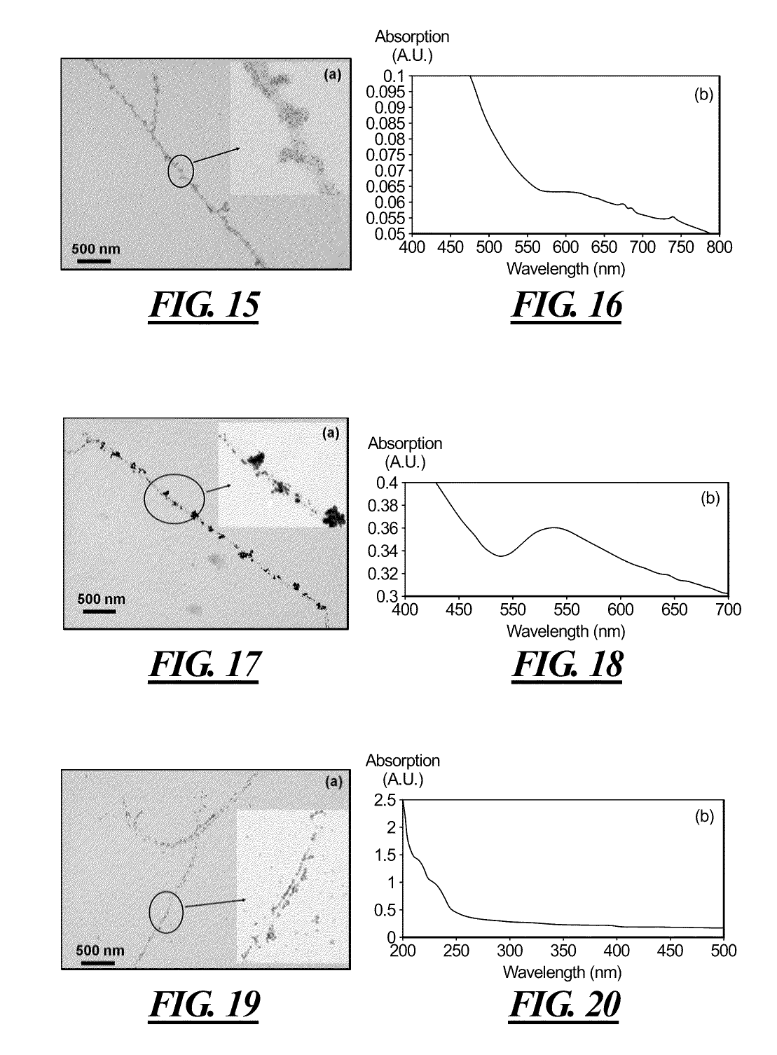

To investigate the capacity of the CNC template synthesis platform to be extended to other inorganic nanoparticle synthesis, metallic nanoparticles of Cu, Au and Pt were also fabricated on CNC surfaces by the general procedure described above (pH=4.5, [CTAB]=0.5 mM, 5 minutes reduction time), and were then characterized by TEM and UV-Vis. The morphology of these metallic nanoparticles was similar to that of Ag nanoparticles as shown in FIGS. 15-20.

FIGS. 15-16 show a bright field TEM image (FIG. 15) of the Cu nanoparticle sample and an absorption spectrum (FIG. 16). The average size of Cu nanoparticles was about 5 nm, and the Cu particles appeared to have agglomerated on the CNC surface (FIG. 15). The UV-Vis absorption peak at about 600 nm indicates the formation of Cu nanoparticles. For the Au synthesis (FIGS. 17-18), the Au nanoparticles appear agglomerated, have a wider range in size (5-20 nm) and form several large gaps along the CNC (FIG. 17). The UV-V is absorption peak (FIG. 18) at about 535 nm indicates the formation of Au nanoparticles. In contrast, for the Pt synthesis (FIGS. 19-20), the average size of the Pt nanoparticles was about 5 nm and the particles were relatively uniformly distributed along the CNC length (FIG. 19). The UV-Vis spectrum peak (FIG. 20) is in the range of about 200-300 nm, indicating the formation of Pt nanoparticles.

### Characterization of Metallic Nanoparticles:

The morphology and size of the metallic nanoparticles deposited on CNC surfaces were characterized by TEM using a Philips CM-10 transmission electron microscope operating at 80 kV. High resolution transmission electron microscopy (HRTEM) images were obtained to study the crystalline nature of the silver nanoparticles on the CNC. HRTEM images were recorded on a FEI Titan 80/300 transmission electron microscope equipped with a Gatan Imaging Filter (GIF) and a 2 k CCD, operating at 300 kV. Electron energy loss (EELS) spectrum was obtained for confirming the presence of silver on the cellulose template. The EELS spectrum was also recorded on the FEI Titan. Additionally, Molecular Device UV-Vis microplate reader was used to measure the UV-Vis spectrum of the Ag, Au, Cu, and Pt nanoparticle chains. The metal nanoparticles were synthesized on CNCs in suspension in an Eppendorf tube. The same synthesis procedure outlined above was used, with a CTAB concentration of 0.5 mM. The UV-Vis spectrum was obtained after the 5 minutes of reducing time.

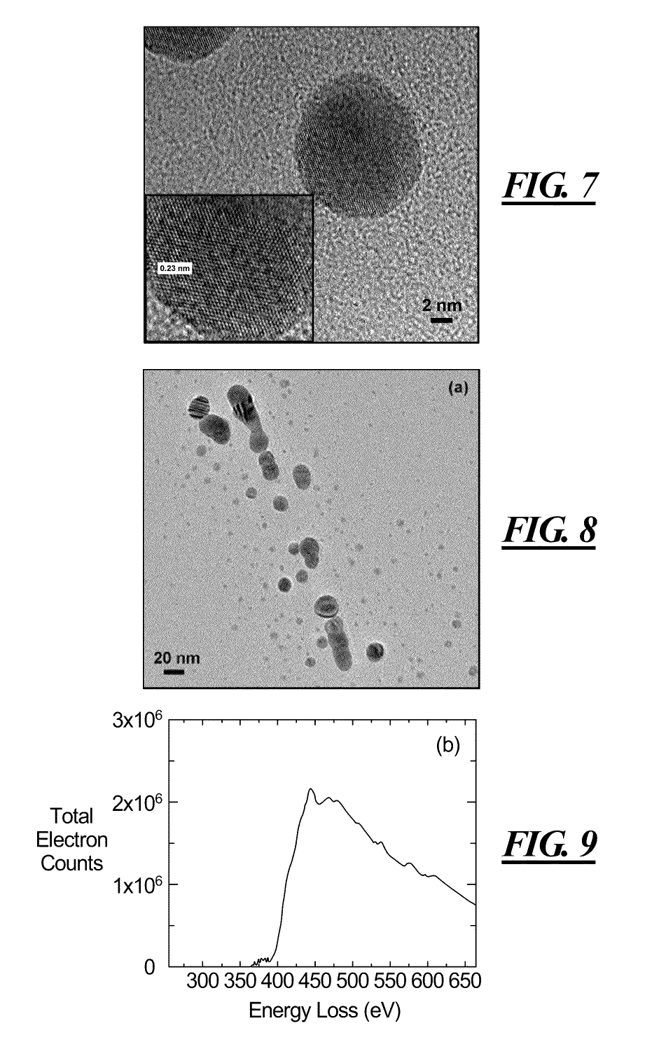

High resolution transmission electron microscopy (HRTEM) imaging confirmed the presence of faceted Ag nanoparticles on the surface of the CNCs. At these extreme magnifications, the CNC was not visible because of the low contrast resulting from the lighter elements (C, H and O) that make up the cellulose as compared to the higher electron density of metallic silver. The HRTEM image (FIG. 7) shows lattice fringes of the Ag nanoparticles, indicating their crystallinity, while the observation that the entire nanoparticle was not in focus indicates that the Ag nanoparticles were facetted. The Ag nanoparticles imaged for this test had an average size of about 20 nm. The interplanar spacing was measured to be about 0.23 nm, and matched well with two (111) planes of Ag (FIG. 7 inset). Additionally, EELS further confirmed the formation of Ag on the CNC surface. FIG. 8 shows a bright field TEM image and FIG. 9 shows an EELS spectrum obtained from the same region shown in FIG. 8. The EELS spectrum very clearly shows an Ag major edge at 367 eV, confirming the formation of Ag nanoparticles.

### Sulfide Nanoparticle Synthesis on CNCs

An electroless deposition technique was used to synthesize CdS, PbS or ZnS nanowires on CNC templates. The precursors used were cadmium chloride (CdCl₂), lead nitrate (Pb(NO₃)₂), and zinc chloride (ZnCl₂) salt solutions, hydrogen sulfide gas (H₂S), and the CTAB surfactant. The precursor salt solutions were used as the source of cadmium (Cd), lead (Pb) and zinc (Zn), respectively, while the H₂S gas was used as the sulfur source. Two deposition configurations were used; one in which deposition occurred while CNCs were initially deposited on a TEM carbon coated copper grid substrate (3 mm diameter), and one in which deposition occurred while CNCs were in solution, with no solid support. Table 1 lists the samples produced using the above procedure:

TABLE 1
Summary of tested experimental conditions.

| | | Salt Con- | | H₂S |
|---|---|---|---|---|
| | Nano- | centration | pH of Salt | Exposure |
| Experiment | particles | (mM) | Solution | Time (min) |
| Substrate method | CdS | 0.8 | 4; 7 | 5 |
| | PbS | 0.5 | 4; 7 | 5 |
| | ZnS | 2.0 | 4; 7 | 5 |
| Substrate method | CdS | 0.8 | 4 (as prepared) | 2 |
| | | | 4 (as prepared) | 5 |
| | | | 4 (as prepared) | 10 |
| | PbS | 0.5 | 4 (as prepared) | 2 |
| | | | 4 (as prepared) | 5 |
| | | | 4 (as prepared) | 10 |
| | ZnS | 2 | 4 | 2 |
| | | | 4 | 5 |
| | | | 4 | 10 |
| Solution method | CdS | 7 | 4 | 5 |
| Solution method | ZnS | 7 | 2 | 5 |

The self-assembly and alignment experiments were performed directly on the TEM grid, solid substrate, for ease of TEM observations. In addition, a limited number of experiments were performed in a solution configuration, to confirm that the procedure is feasible both on a solid support and in the absence of such support.

For the substrate configuration, 3 μL of the diluted CNC suspension was pipetted on a TEM grid. This dilution avoided the formation of a matt-like structure on the substrate. Then, an aqueous solution of the surfactant CTAB (0.5 mM, 3 μL) was added and the mixture was incubated for about 5 min. This was followed by the addition of a given precursor salt solution (3 μl), CdCl₂ (0.8 mM), Pb(NO₃)₂ (0.5 mM), and ZnCl₂ (2.0 mM), at a set pH (2, 4 or 7) and the resulting mixture was incubated for another 5 min. Next, H₂S gas was passed over the substrate for 2, 5 or 10 min. The substrate was then washed with distilled water and dried in air. Another set of experiments was also carried out for CdS, PbS and ZnS. These experiments were performed in the absence of CTAB, to emphasize on the importance of CTAB in the synthesis process.

For the self-assembly experiments performed in solution, without a solid support, CTAB (0.5 mM) was added to 3 μL of the diluted CNC suspension and incubated for 5 min. This was followed by the addition of a given precursor salt solution (3 μl), CdCl₂ (7 mM), and ZnCl₂ (7 mM), at a set pH (2 or 4) and the resulting mixture was incubated for another 5 min. Next, H₂S gas was passed over the substrate for 5 min. Samples were collected from this solution and deposited on a carbon coated TEM grid for imaging.

The reaction time was kept constant at 5 min for all experiments, and the pH of the salt solution was varied between from about 4 to about 7, as specified above. To obtain an acidic salt solution, HCl was added, while NH₄OH was added to make the solution basic. The pH of the salt solution was measured using a pH meter prior to each synthesis experiment.

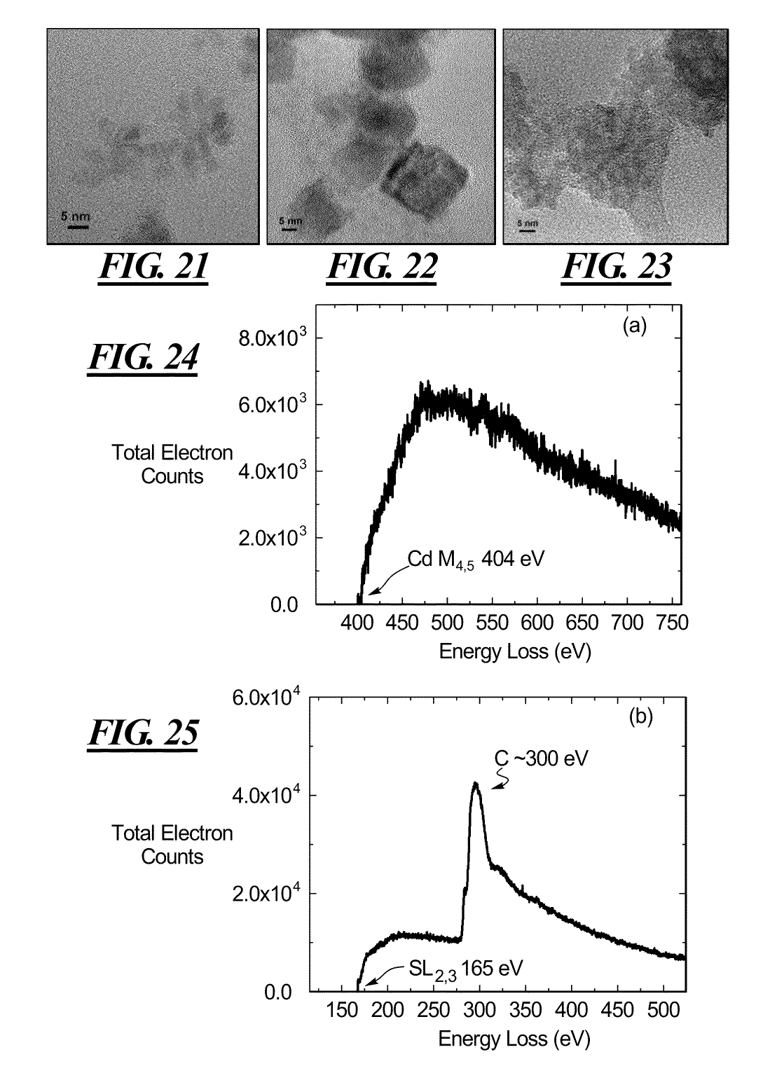

With the inclusion of CTAB into the reaction process, semiconducting nanostructures (CdS, PbS and ZnS) were successfully formed preferentially on CNC surfaces, with only trace formations on the TEM grid substrate. By adjusting processing conditions semiconducting nanoparticles aligned on the CNC surface in virtually continuous chains, as shown in FIG. 2 for CdS. The average particles size, as measured by TEM, was approximately 55 nm. In general, the CdS and ZnS particles that were assembled on the surface of the CNCs were agglomerates of much smaller sized particles. HRTEM images of CdS and ZnS nanoparticles confirmed that the agglomerates consist of several nanocrystals with sizes ranging from about 2 to about 6 nm. In contrast, PbS particles are single crystals with a cubic morphology, as evident from the lattice fringes present in the HRTEM images. The HRTEM images of typical CdS, PbS, and ZnS particles are shown in FIGS. 21-23 respectively.

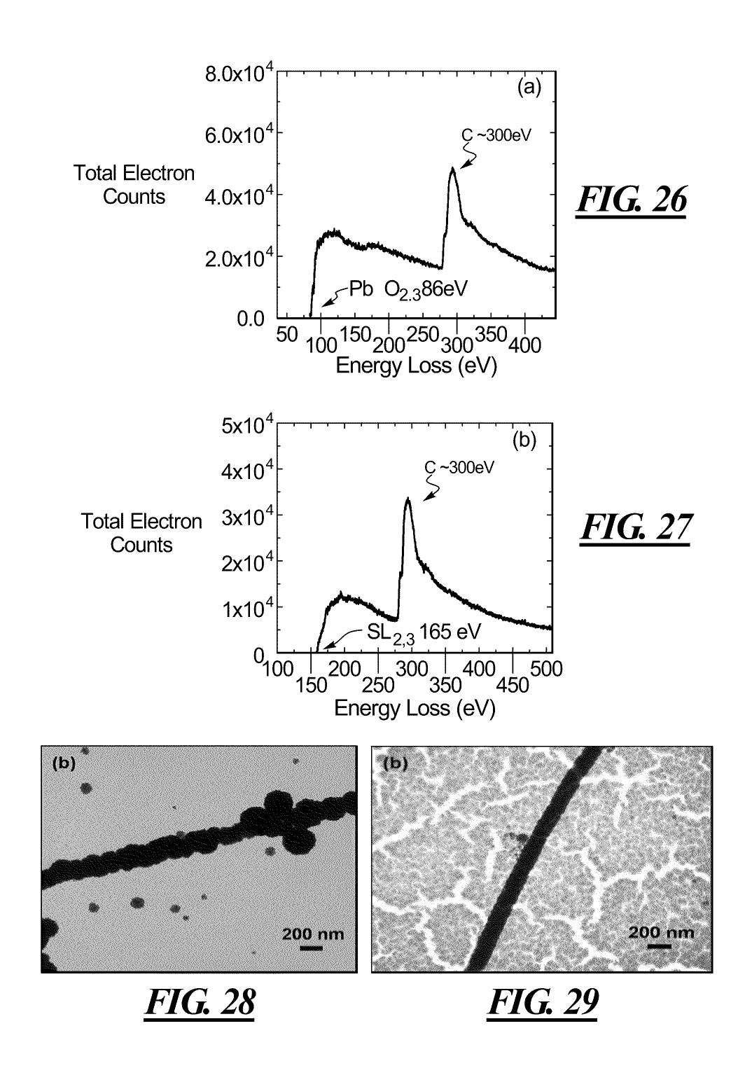

EELS spectra confirmed the chemical composition of the CdS (FIGS. 24-25), and PbS (FIGS. 26-27) nanoparticles formed on the CNCs. For the CdS sample, the EELS spectra show the cadmium M_{4,5} edge at 404 eV (FIG. 24) and the sulfur L_{2,3} edge at 165 eV (FIG. 25). Likewise, for the PbS sample, the lead O_{2,3} edge at 86 eV (FIG. 26) and sulfur L_{2,3} edge at 165 eV (FIG. 27). Both spectra also show the Carbon K edge at 300 eV, likely resulting from the carbon TEM grid.

The solution preparation method showed similar results to the substrate method in that the inclusion of CTAB was necessary for nanoparticles to attach themselves on the surface of CNCs. By adjusting the processing conditions it was possible to form complete nanoparticle coverage of the CNC forming tube or wire-like structures (FIGS. 28-29).

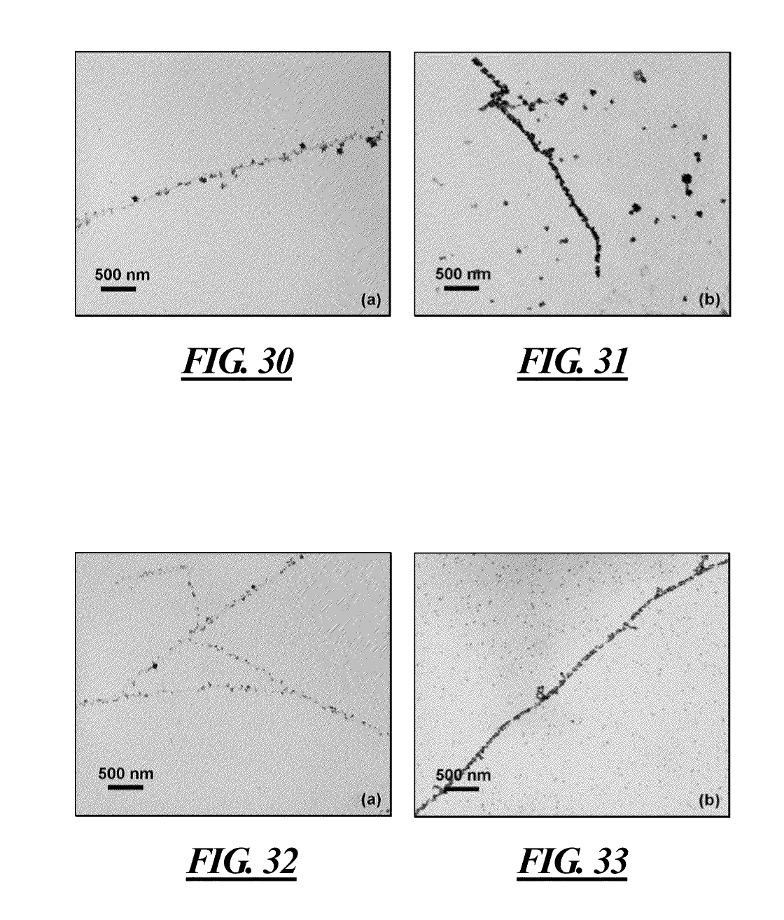

To maximize the coverage of the semiconductor nanoparticles on the CNCs, two fabrication parameters (pH of salt solution and H₂S exposure time) were systematically varied to assess their role in resulting nanoparticle chain assembly on the CNC surface. The influence of the pH of the precursor solution on the particle size and morphology investigated for CdS and ZnS nanoparticles via TEM imaging. For these experiments, the CdCl₂ concentration was 0.8 mM and that of ZnCl₂ was 2 mM. It was observed that both the particle size and the density of nanoparticles on the CNC surface increased as the pH of the salt solution increased, as shown in FIGS. 30-33. The reaction mechanism that describes this process is a follows for an acidic medium:

H₂S+H₂O═S+HS+H+OH (1)

S+H═HS (2)

In a basic medium the following reaction becomes valid:

HS+OH═S+H₂O (3)

In an acidic medium there are less S ions available to react with the cations and therefore less nanoparticle product can form and further align on the CNCs. In contrast, as the pH of the medium increases, more S anions are available to combine with the cations, increasing the nucleation and growth rates. Similar trends of increase in particle size and density with an increase in pH were observed for all CdS, PbS, and ZnS nanoparticle samples.

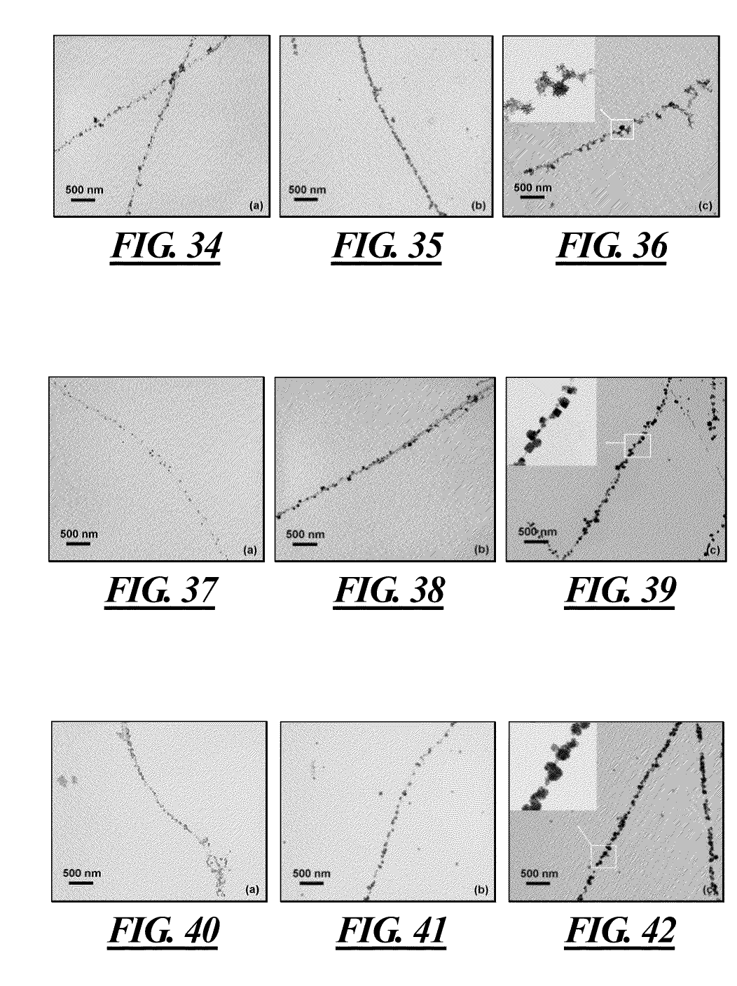

In FIGS. 34-42, the influence of the H₂S exposure time (2 min (FIGS. 34, 37, 40), 5 min (FIGS. 35, 38, 41) to 10 min (FIGS. 36, 39, 42)) on the particle size and morphology was investigated for PbS (FIGS. 34-36), CdS (FIGS. 37-39) and ZnS (FIGS. 40-42) nanoparticles via TEM imaging. Comparing the 10 min TEM images of (FIGS. 36, 39, 42) with the 2 min TEM images of (FIGS. 34, 37, 40), FIGS. 34-42 clearly show an increase in particle size with an increase in exposure time. The cubic morphology of the PbS nanoparticles (FIG. 39 inset) is due to the rock salt cubic structure of PbS. While the PbS seems to assemble into single grains aligned along the CNC surface, the morphology of CdS and ZnS nanoparticles appears to be composed of several small nanocrystals clumping together to form a larger crystallite, with the individual size of the nanocrystals ranging from 2 to 6 nm.

Experiments were also performed where CdS nanoparticles were synthesized without the CNC template and either in the presence of CTAB or without CTAB. When CTAB was used in the synthesis, the CdS particles appear well formed and dispersed, but randomly distributed (FIG. 44). In contrast, without CTAB, there was significant agglomeration of the CdS particles (FIG. 45). These results indicate that CTAB acts as a nanoparticle stabilizer and self-assembly vehicle for the alignment of the CdS nanoparticles on the 1D CNC templates.

Without being bound to any particular theory, based on literature results and on our experimental results (e.g. FIGS. 1-2, FIGS. 44-45), a proposed mechanism begins with CTAB acting as a nanoparticle stabilizer inside its micellar core, a role that was previously reported in literature. In the proposed mechanism, CdS, PbS and ZnS nanoparticles may first be formed via the chemical reaction between precursor salts and H₂S, and CTAB acts as a stabilizer forming small agglomerates (containing individual size nanocrystals ranging from about 2 to about 6 nm) as shown in FIG. 44. In the subsequent step, it is proposed that the nanoparticles-CTAB assemblies may non-covalently attach to the hydrophilic hydroxyl groups that cover the surface of the CNCs. The CNC rod-like structure is thus acting as a template for semiconductor nanoparticle deposition, the resulting hybrid inorganic-biological structure being that of 1D assemblies (i.e. tube or wire-like structures).

### Characterization of Sulfide Nanoparticles:

The resulting semiconducting particles were characterized with a Philips CM-10 TEM, operating at 80 kV. High resolution transmission electron microscopy (HRTEM) images were obtained to study the crystalline nature of the semiconducting nanowires. HRTEM images were recorded on a FEI Titan 80/300 transmission electron microscope equipped with a Gatan Imaging Filter (GIF) and a 2 k CCD, operating at 300 kV. The electron energy loss (EELS) spectrum was obtained with the same equipment, and used to confirm the chemical composition of CdS, PbS and ZnS nanostructures.

### Results and Discussion:

The fabrication of semiconducting nanoparticles onto the surface of a biological template displaying negative charges on their surface, such as DNA, viruses or fibrillar proteins, can be achieved by various methods (UV, gamma irradiation, electroless deposition). The electroless deposition technique is often used due to its simplicity and mild synthetic conditions. However, this method is not easily applicable to natural biopolymers, which possess mostly neutral hydroxyl groups that may not readily interact with the cations during the initial electrostatic interaction step in the synthesis process. The driving force of the deposition reaction relies on the difference between the redox potentials of the biomolecules and those of the protein or DNA. Presently, the method is widely applied for the detection of proteins and nucleic acids in silver stained gels. However, this approach registered very limited success in our initial attempts to use CNCs as biological templates for semiconductor nanostructures synthesis without the inclusion of CTAB to the processing method (FIG. 1). It is considered here that the negatively charged sulfate groups remaining on CNC surfaces after acid hydrolysis did not sufficiently interact with cations to cause the precipitation of semiconducting nanoparticles.

### INDUSTRIAL APPLICABILITY

The surface of tunicate CNCs were decorated along the length with metallic nanoparticles. For the first time, a cationic surfactant (CTAB) was used, not only as a stabilizer of metallic nanoparticles, but also as a vehicle for the positioning of these particles on the CNCs surface. This method resulted in successful decoration of CNCs' surface with Ag, Cu, Au, Pt, CdS, ZnS and PbS nanoparticles. The nanoparticles were poly-dispersed, which was believed to result from a competing nucleation and growth mechanism that dominates their formation. The average size of the nanoparticles and coverage on the CNC was controlled by varying the concentration of the surfactant, salt solution, the reaction time and pH of the salt solution. The results indicate that the same hybrid platform could be extended to serve as an alternative method for engineering a variety of functional materials at the nanometric level. This hybrid universal platform could present advantages over DNA or protein templating in terms of costs, simplicity and versatility and as such offers advantages for translating the fabrication of functional nanomaterials into real life electronic and optical nanodevices.

Nano scale particles of gold, platinum and other rare elements are particularly active as catalysts because of the extremely high surface area of the particles and surface chemistry effects unique to near-atomic scale particles. Physically attaching these nano-scale particles to a nano-diameter cellulose fibers maintains the high surface area and activity, but the micron length scale of the cellulose nano-fiber provides a dimension readily that can be used to maintain a fine dispersion of the nanoparticles while also providing the capability to recover the catalyst. Similarly, the above description can also be applied for the nanoscale silver particles, which have antimicrobial functionality.

Additionally, preliminary results suggest the use of CTAB also results in more uniform particle size (FIGS. 44 and 45). The particles are still polydispersed, but the size distribution is less as there is less agglomeration of particles. Since the unique properties of nanoparticles are a result of their near-atomic size and surface area, the ability to produce particles having a tighter size distribution would result in a more uniform reactivity.

What is claimed is:

1. A method for synthesizing metal-containing nanostructures on cellulose nanocrystals (CNCs), the method comprising:
exposing the CNCs to a cationic surfactant and a metal precursor; and
exposing the CNCs, cationic surfactant and metal precursor to a reducing agent.

2. The method of claim 1 wherein the cationic surfactant is cetyltrimethylammonium bromide (CTAB).

3. The method of claim 2 wherein the exposing of the CNCs to the CTAB is carried out in the presence of a solid support and the CTAB is provided in an aqueous solution.

4. The method of claim 3 wherein the solid support is a transition electron microscope (TEM) carbon coated copper grid substrate.

5. The method of claim 2 wherein the exposing of the CNCs to the CTAB is carried out in an acidic, aqueous solution.

6. The method of claim 5 wherein a pH of the acidic, aqueous solution ranges from about 4 to about 2.

7. The method of claim 5 wherein the CTAB solution has a concentration ranging from about 0.1 to about 1.0 mM.

8. The method of claim 7 wherein the CTAB solution has a concentration of about 0.5 mM.

9. The method of claim 1 wherein the metal precursor is provided in the form of an aqueous solution.

10. The method of claim 9 wherein the metal precursor solution has a concentration ranging from about 0.5 to about 0.8 mM.

11. The method of claim 9 wherein the metal precursor is selected from the group consisting of AgNO₃, CuCl₂, HAuCl₄, K₂PtCl₄, CdCl₂, Pb(NO₃)₂ and ZnCl₂.

12. The method of claim 1 wherein the reducing agent is selected from the group consisting of NaBH₄ and H₂S.

13. The method of claim 12 wherein the reducing agent is NaBH₄ and the NaBH₄ provided in a 0.03 wt % solution and the exposing of the CNCs, CTAB and metal precursor to the 0.03 wt % NaBH₄ solution is carried out over a time period ranging from about 2 to about 30 minutes.

14. The method of claim 12 wherein the reducing agent is H₂S gas and the exposing of the CNCs, CTAB and metal precursor to the H₂S gas is carried out over a time period ranging from about 2 to about 10 minutes.

15. The method of claim 1 wherein, before the exposing of the CNCs to the cationic surfactant, the CNCs are hydrolyzed with sulfuric acid to provide sulfate-functionalized CNCs.

16. The method of claim 1 wherein the CNCs are tunicate CNCs.

17. A method for synthesizing metal nanostructures on cellulose nanocrystals (CNCs), the method comprising:
providing CNCs in an aqueous, acidic solution;
combining the CNCs with a cetyltrimethylammonium bromide (CTAB) solution and a metal precursor solution, the metal precursor solution being selected from the group consisting of an AgNO₃ solution, a CuCl₂ solution, a HAuCl₄ solution and a K₂PtCl₄ solution; and
exposing the CNCs, CTAB and metal precursor to NaBH₄.

18. The method of claim 17 wherein the NaBH₄ is provided in a 0.03 wt % solution and the exposing of the CNCs, CTAB and metal precursor to the 0.03 wt % NaBH₄ solution is carried out over a time period ranging from about 2 to about 30 minutes.

19. A method for synthesizing metal nanostructures on cellulose nanocrystals (CNCs), the method comprising:
providing CNCs in an aqueous, acidic solution;
exposing the CNCs to a cetyltrimethylammonium bromide (CTAB) solution and a metal precursor solution, the metal precursor solution being selected from the group consisting of a CdCl₂ solution, a ZnCl₂ solution and a Pb(NO₃)₂ solution; and
exposing the CNCs, CTAB and metal precursor to H₂S gas.

20. The method of claim 16 wherein the exposing of the CNCs, CTAB and metal precursor to the H₂S gas is carried out over a time period ranging from about 2 to about 10 minutes.
